(19) United States
(12) Patent Application Publication
(10) Pub. No.: US 2018/0092038 A1
(43) Pub. Date: Mar. 29, 2018

(54) WIRELESS TERMINAL, WIRELESS SYSTEM, WIRELESS NETWORK, WIRELESS COMMUNICATION METHOD AND PROGRAM

(71) Applicant: NEC CORPORATION, Tokyo (JP)

(72) Inventors: Toru YAMADA, Tokyo (JP); Akira KAMEI, Tokyo (JP); Masahiro SERIZAWA, Tokyo (JP); Hotaka SUGANO, Tokyo (JP); Satoshi HASEGAWA, Tokyo (JP); Masashi SHIMOMA, Tokyo (JP)

(73) Assignee: NEC CORPORATION, Tokyo (JP)

(21) Appl. No.: 15/562,634

(22) PCT Filed: Mar. 29, 2016
(86) PCT No.: PCT/JP2016/060042

§ 371 Date: Sep. 28, 2017

(30) Foreign Application Priority Data
Mar. 31, 2015 (JP) 2015-071601

(51) Int. Cl. H04W 52/02

(52) U.S. Cl. CPC H04W 52/0235; H04W 76/048; H04W 76/06; H04W 52/0248

(57) ABSTRACT

The present invention relates to a wireless terminal that includes an operation disabling instruction generation means for generating an operation disabling instruction that disables a transmission operation of a wireless terminal based on a specified trigger, and an operation disabling means for disabling the transmission operation of the wireless terminal based on the operation disabling instruction.

### TECHNICAL FIELD

The present invention relates to a wireless terminal, a wireless system, a wireless network, a wireless communication method and a program.

### BACKGROUND ART

Use of a communication network is spreading from general terminals with direct involvement by humans, such as smartphones and PCs (Personal Computers), to wireless terminals without direct involvement in communication by humans, such as meters, vending machines and electronic advertisements. Such communication without direct involvement by humans is called MTC (Machine Type Communication), and a wireless terminal without direct involvement in communication by humans is called an MTC terminal or an M2M (Machine-to-Machine) terminal. Further, a device, a sensor and the like that are used in IoT (Internet of Things) are also included in them. Note that, in the following description, an MTC terminal, an M2M terminal, a device, a sensor and the like used in IoT are collectively referred to as “MTC terminal etc.”.

In the case of MTC, it is considered that the frequency of communication required for an MTC terminal is lower (for example, once a day, once a week, once a month etc.) than that for a general wireless terminal, and the amount of data used for one-time communication is not large. Further, many MTC terminals operate by battery, and it is necessary to maintain the sleep mode as long as possible when not receiving data to thereby extend the service life so that it can operate for as long as several to ten years.

### SUMMARY OF INVENTION

### Technical Problem

However, there can be a case where a service using the MTC terminal is discontinued due to various external factors. In such a case, it is necessary to stop a large number of MTC terminals used in this service, but because the number of MTC terminals used is large and those MTC terminals need to be stopped or recovered by human hands, the MTC terminals are operating autonomously by battery during that period and therefore it continues to transmit radio waves. As a result, it can cause radio wave interference with another communication service or the like, which gives rise to a problem.

The present invention has been accomplished to solve the above problem and an exemplary object of the present invention is to provide a wireless terminal, a wireless system, a wireless network, a wireless communication method and a program that disable the transmission operation of a wireless terminal.

### Solution to Problem

One exemplary aspect of the present invention is a wireless terminal that includes an operation disabling instruction generation means for generating an operation disabling instruction that disables a transmission operation of a wireless terminal based on a specified trigger, and an operation disabling means for disabling the transmission operation of the wireless terminal based on the operation disabling instruction.

One exemplary aspect of the present invention is a wireless communication system that includes a transmission means for transmitting a message related to disabling a transmission operation of a wireless terminal, an operation disabling instruction generation means for generating an operation disabling instruction that disables a transmission operation of a wireless terminal based on the message, and an operation disabling means for disabling the transmission operation of the wireless terminal based on the operation disabling instruction.

One exemplary aspect of the present invention is a wireless communication method that includes generating an operation disabling instruction that disables a transmission operation of a wireless terminal based on a specified trigger, and disabling the transmission operation of the wireless terminal based on the operation disabling instruction.

One exemplary aspect of the present invention is a program that causes a computer to execute processing for generating an operation disabling instruction that disables a transmission operation of a wireless terminal based on a specified trigger, and processing for disabling the transmission operation of the wireless terminal based on the operation disabling instruction.

One exemplary aspect of the present invention is a wireless network that includes a trigger transmission means for transmitting, to a wireless terminal including an operation disabling instruction generation means for generating an operation disabling instruction that disables a transmission operation of a wireless terminal and an operation disabling means for disabling the transmission operation of the wireless terminal based on the operation disabling instruction, a trigger that activates generation of the operation disabling instruction.

### Advantageous Effects of Invention

According to the exemplary aspects of the present invention, it is possible to disable the transmission operation of a wireless terminal.

### BRIEF DESCRIPTION OF DRAWINGS

FIG. 1 is a block diagram illustrating the overview of the present invention.

FIG. 2 is an operational flowchart according to the present invention.

FIG. 3 is a schematic view of a wireless communication system according to a first exemplary embodiment.

FIG. 4 is a block diagram of an MTC terminal 10 according to the first exemplary embodiment.

FIG. 5 is a view illustrating a current path at the time of normal operation according to the first exemplary embodiment.

FIG. 6 is a view illustrating a current path at the time of discharge of a battery 17 according to the first exemplary embodiment.

FIG. 7 is a block diagram of a base station 20 according to the first exemplary embodiment.

FIG. 8 is a block diagram of an application server 30 according to the first exemplary embodiment.

FIG. 9 is an operational flowchart of the MTC terminal 10 according to the first exemplary embodiment.

FIG. 10 is a schematic view of a wireless communication system according to a second exemplary embodiment.

FIG. 11 is a block diagram of an MTC terminal 10 according to the second exemplary embodiment.

FIG. 12 is a view illustrating a current path at the time of normal operation according to the second exemplary embodiment.

FIG. 13 is a view illustrating a current path at the time of discharge of a battery 17 according to the second exemplary embodiment.

FIG. 14 is an operational flowchart of the MTC terminal 10 according to the second exemplary embodiment.

FIG. 15 is a block diagram of a wireless terminal that operates by a computer program.

### DESCRIPTION OF EMBODIMENTS

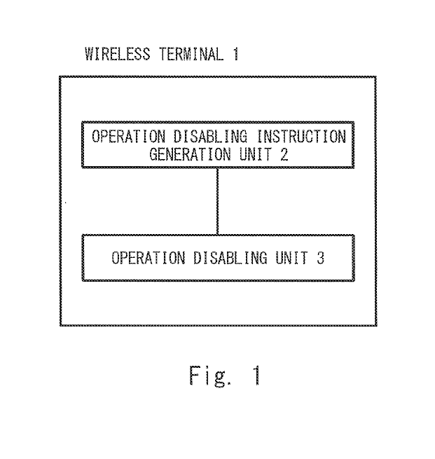

The overview of the present invention is described hereinafter. FIG. 1 is a block diagram for illustrating the overview of the present invention.

A wireless terminal 1 according to the present invention includes an operation disabling instruction generation unit 2 that generates an operation disabling instruction for disabling the transmission operation of the wireless terminal 1 based on a specified trigger, and an operation disabling unit 3 that disables the transmission operation of the wireless terminal 1 based on the operation disabling instruction.

The type of the wireless terminal 1 is not limited, and it may include not only a smartphone and a PC but also an MTC (Machine Type Communication) terminal, an M2M (Machine-to-Machine) terminal, and a device, a sensor and the like that are used in IoT (Internet of Things), for example. Particularly, the present invention is effective in the case where the wireless terminal 1 is the MTC terminal etc. since there is a request for stopping the transmission operation of the MTC terminal etc. for reasons such as the discontinuation of a service due to various external factors and the adverse effects of the operation of the MTC terminal etc., like radio wave interference by transmission, caused by the passage of a specified operating time or the like.

Further, the specified trigger is an event that causes the function of the wireless terminal 1, particularly the transmission operation, to be disabled, and it may be a trigger from the outside such as a message from a wireless network that communicates with the wireless terminal 1, a trigger generated by the wireless terminal 1 such as a trigger generated by the passage of a specified operating time of the wireless terminal 1, for example. Note that the trigger may be the one that disables not only the transmission operation but also the reception operation.

Based on such a specified trigger, the operation disabling instruction generation unit 2 generates an operation disabling instruction that at least disables the transmission operation of the wireless terminal 1. Note that the operation disabling instruction may be an instruction that disables not only the transmission operation but also the reception operation.

The operation disabling unit 3 at least disables the transmission operation of the wireless terminal 1 based on the operation disabling instruction generated by the operation disabling instruction generation unit 2. A method for disabling the transmission operation of the wireless terminal 1 may be a method that adds a function of turning on and off a transmitter of the wireless terminal 1 and turns off the transmitter upon receiving the operation disabling instruction, a method that discharges the battery of the wireless terminal 1 and thereby stops the operation of the transmitter or the like. Note that the operation disabling unit 3 may disable not only the transmission operation but also the reception operation.

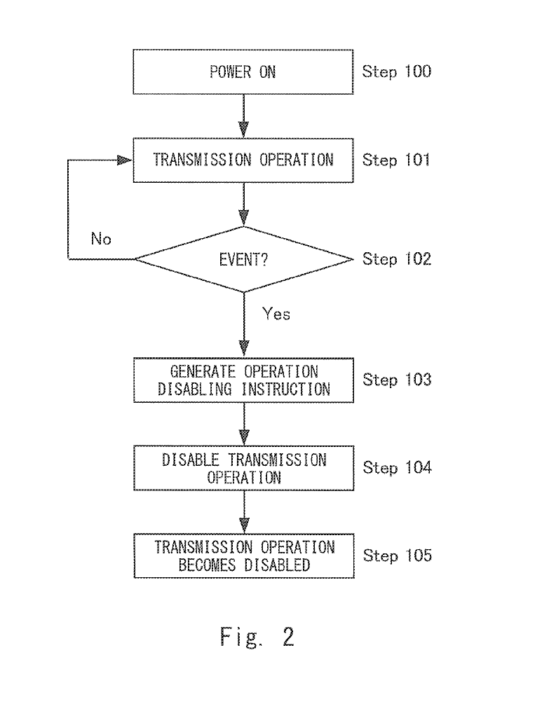

The operation of the present invention is described hereinafter. FIG. 2 is an operational flowchart according to the present invention.

First, the wireless terminal 1 is powered on (Step 100), and the transmission operation of the wireless terminal 1 is initiated (Step 101).

The operation disabling instruction generation unit 2 monitors a specified event (Step 102), and when a specified event occurs, generates the operation disabling instruction (Step 103). When there is no specified event, the transmission operation of the wireless terminal 1 is performed (Step 101).

When the operation disabling unit 3 receives the operation disabling instruction, it disables the transmission operation of the wireless terminal 1 (Step 104). Then, the transmission operation of the wireless terminal 1 becomes disabled (Step 105).

As described above, according to the present invention, it is possible to disable the transmission operation of the wireless terminal 1 by the generation of a specified event, without any involvement by humans. It is thereby possible to prevent the adverse effects, such as radio wave interference, for example, by the wireless terminal that has become needless by the discontinuation of a service or the like. Further, because it is possible to disable the transmission operation of the wireless terminal 1 by the generation of one event, it is significantly effective compared with recovery by humans and achieves cost reduction.

Specific exemplary embodiments are described hereinbelow.

### First Exemplary Embodiment

In the first exemplary embodiment, the case where the specified event is a message related to disabling the transmission and reception operation of a wireless terminal which is transmitted from a wireless network, and the method for disabling the transmission and reception operation is a method that discharges the battery of a wireless terminal is described. Further, the case where the wireless terminal is an MTC terminal is described.

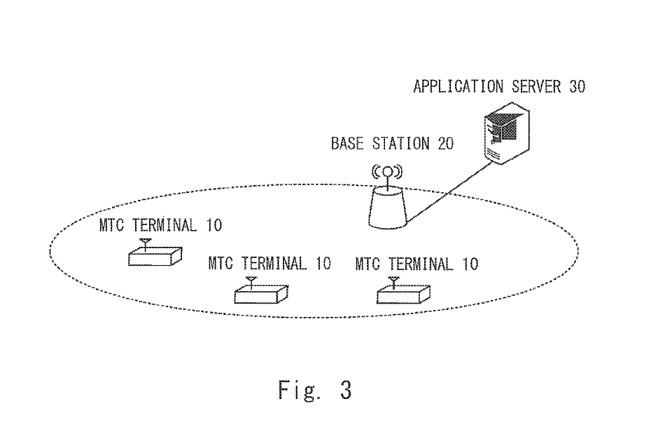

FIG. 3 is a schematic view of a wireless communication system according to the first exemplary embodiment.

The wireless communication system according to the first exemplary embodiment includes a plurality of MTC terminals 10, a base station 20, and an application server 30.

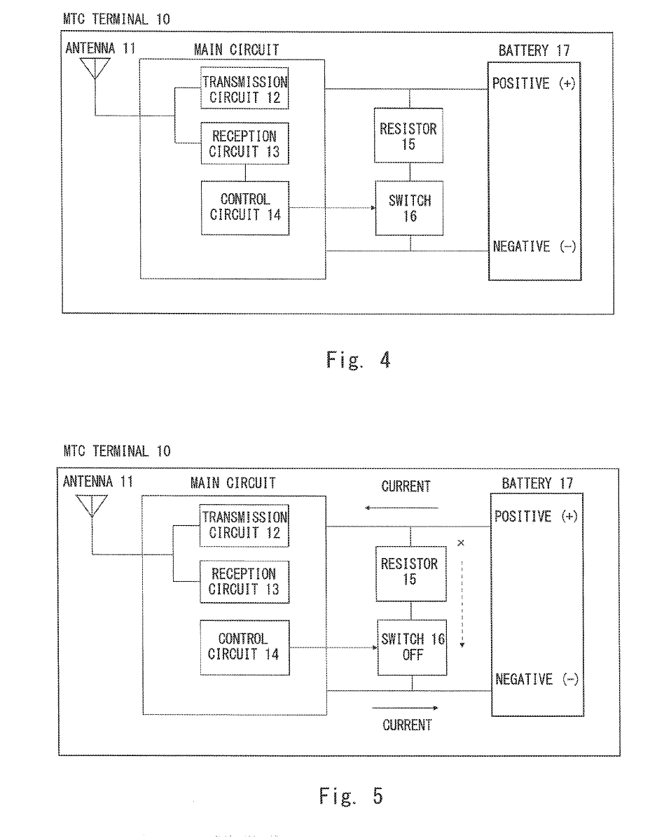

FIG. 4 is a block diagram of the MTC terminal 10 according to the first exemplary embodiment.

In FIG. 4, the MTC terminal 10 includes an antenna 11, a transmission circuit 12, a reception circuit 13, a control circuit 14, a resistor 15, a switch 16, and a battery 17.

The transmission circuit 12 and the reception circuit 13 are parts that transmit and receive radio signals to and from the base station 20, respectively.

The control circuit 14 monitors a message related to disabling the transmission and reception operation of the MTC terminal 10 which is transmitted from the base station 20. When the control circuit 14 receives the message, it controls the switch 16 (controls the switch 16 by generating the operation disabling instruction), and discharges electric power remaining in the battery 17 safely through the resistor 15 with an appropriate value, and thereby disables the operation of the transmission circuit 12 and the reception circuit 13.

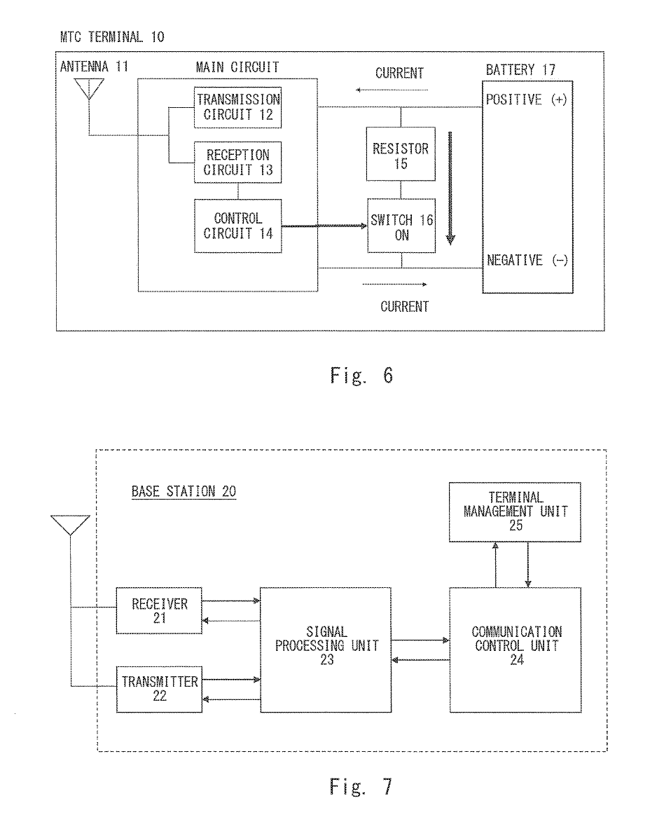

The processing for disabling the operation of the transmission circuit 12 and the reception circuit 13 by discharge of the battery 17 is described hereinafter. FIG. 5 is a view illustrating a current path at the time of normal operation, and FIG. 6 is a view illustrating a current path at the time of discharge of the battery 17.

First, as shown in FIG. 5, at the time of normal operation, the control circuit 14 turns off the switch 16, and a current from the battery 17 is supplied to a main circuit that includes the transmission circuit 12, the reception circuit 13 and the control circuit 14. Thus, no current flows to the resistor 15 and the switch 16.

On the other hand, when the message is received, the control circuit 14 turns on the switch 16 (turns on the switch 16 by generating the operation disabling instruction). Then, a current from the battery 17 begins to flow also to the resistor 15 and the switch 16. As a result that a current from the battery 17 flows also to the resistor 15 and the switch 16, the remaining capacity of the battery 17 decreases rapidly. When the remaining capacity of the battery 17 falls below a normal capacity, the positive voltage of the battery 17 decreases, and at the point of time when it decreases to the minimum operating voltage at which the transmission circuit 12 and the reception circuit 13 can operate, the operation of the main circuit that includes the transmission circuit 12, the reception circuit 13 and the control circuit 14 stops, and thereby the transmission of radio waves from the antenna also stops.

By setting the current value flowing to the resistor 15 and the switch 16 to a value that does not exceed the maximum allowable discharge current (Imax) of the battery 17, it is possible to discharge the remaining capacity of the battery 17 safely. At this time, the rated power (Wr) of the resistor 15 (R) is calculated by the following equation from Ohm's Law based on the maximum discharge current (Imax) of the battery 17.

Wr(W)=Imax(A)²×R(Ω)

Then, the resistor 15 with a rated power that is twice or more the rated power (Wr) is selected in consideration of derating.

Further, the switch 16 may be a semiconductor device or a switch with a mechanical contact point. In the case of using the switch 16 which is a semiconductor device, a semiconductor device where the maximum allowable current of the semiconductor device is twice or more the maximum allowable discharge current of the battery 17 is selected in consideration of derating. Further, in the case of using the switch 16 with a mechanical contact point, the switch 16 where the maximum switching current is twice or more the maximum allowable discharge current of the battery 17 is selected.

The base station 20 according to the first exemplary embodiment is described hereinafter.

FIG. 7 is a block diagram of the base station 20 according to the first exemplary embodiment.

In FIG. 7, the base station 20 includes a receiver 21, a transmitter 22, a signal processing unit 23, a communication control unit 24, and a terminal management unit 25. Further, the communication control unit 24 has a function of receiving a message related to disabling the transmission and reception operation of the MTC terminal 10 from the application server 30 and transferring the message to the MTC terminal 10. The terminal management unit 25 individually manages each of a plurality of MTC terminals 10.

The application server 30 according to the first exemplary embodiment is described hereinafter.

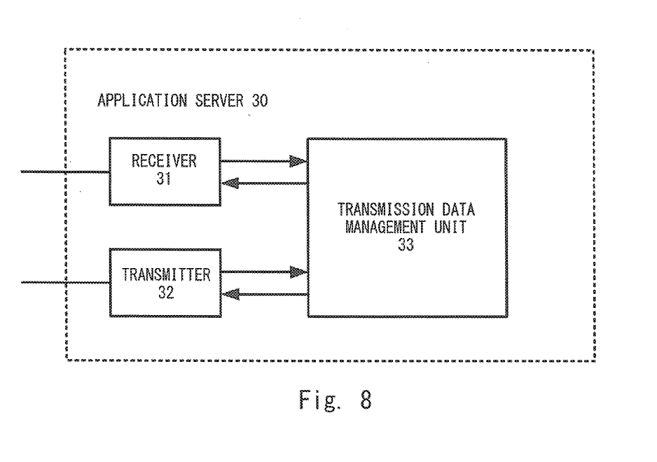

FIG. 8 is a block diagram of the application server 30 according to the first exemplary embodiment.

The application server 30 includes a receiver 31 that receives a signal from the base station 20, a transmitter 32 that transmits a signal to the base station 20, and a transmission data management unit 33 that manages a message related to disabling the transmission and reception operation to be transmitted to the MTC terminal 10. The transmission data management unit 33 has a function of transmitting the message related to disabling the transmission and reception operation to the base station 20 when it intends to stop or disable the transmission and reception operation of the MTC terminal 10 for reasons such as service discontinuation.

The operation of the MTC terminal 10 in the wireless communication system according to the first exemplary embodiment is described hereinafter.

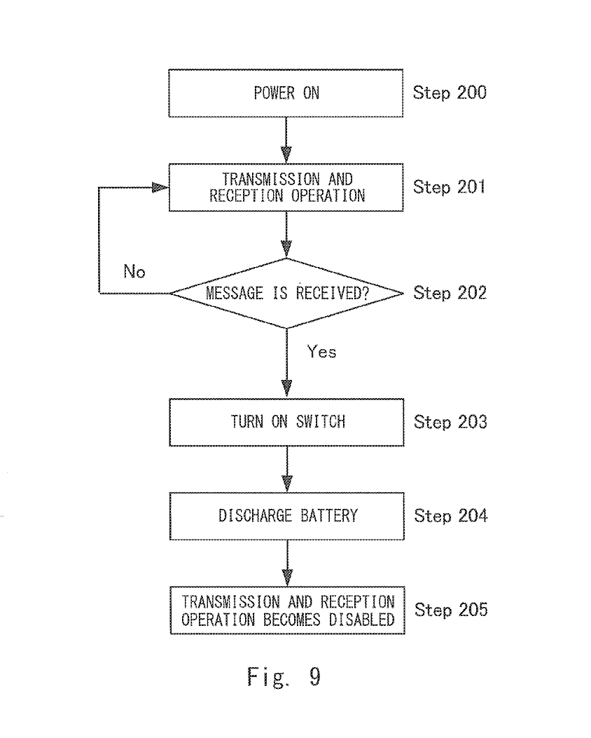

FIG. 9 is an operational flowchart of the MTC terminal 10 according to the first exemplary embodiment.

First, the MTC terminal 10 is powered on (Step 200), and the transmission operation of the MTC terminal 10 is initiated (Step 201). At this time, the control circuit 14 turns off the switch 16, and thereby a current from the battery 17 is supplied to the main circuit that includes the transmission circuit 12, the reception circuit 13 and the control circuit 14, and a normal transmission and reception operation is performed.

The control circuit 14 monitors a message related to disabling the transmission and reception operation (Step 202), and when it receives the message related to disabling the transmission and reception operation, the control circuit 14 turns on the switch 16 (turns on the switch 16 by generating the operation disabling instruction) (Step 203). Then, a current from the battery 17 begins to flow also to the resistor 15 and the switch 16. As a result that a current from the battery 17 flows also to the resistor 15 and the switch 16, the remaining capacity of the battery 17 decreases rapidly (Step 204). When the remaining capacity of the battery 17 falls below a normal capacity, the positive voltage of the battery 17 decreases, and at the point of time when it decreases to the minimum operating voltage at which the transmission circuit 12 and the reception circuit 13 can operate, the operation of the main circuit that includes the transmission circuit 12, the reception circuit 13 and the control circuit 14 stops, and the transmission of radio waves from the antenna also stops, and thereby the transmission and reception operation of the MTC terminal 10 becomes disabled (Step 205).

On the other hand, the control circuit 14 monitors a message related to disabling the transmission and reception operation (Step 202), and when it does not receive the message related to disabling the transmission and reception operation, the control circuit 14 keeps the switch 16 off, and a normal transmission and reception operation is performed (Step 201).

As described above, this exemplary embodiment has an advantageous effect that the MTC terminal enters the transmission and reception stopped or disabled state upon receiving a message from the outside, and maintains this state to thereby reduce interference with the outside.

Further, because it is possible to allow many MTC terminals to enter the transmission and reception stopped or disabled state only with a message from the application server, it is significantly effective compared with recovery by humans and achieves cost reduction.

Further, because electric power remaining in the battery of the MTC terminal is discharged through the resistor with an appropriate value, it is possible to allow the MTC terminal to enter the transmission and reception stopped or disabled state safely.

### Second Exemplary Embodiment

In the second exemplary embodiment, the case where the specified event is the passage of a specified operating time of a wireless terminal, and the method for disabling the transmission and reception operation is a method that discharges the battery of a wireless terminal is described. Further, the case where the wireless terminal is an MTC terminal is described.

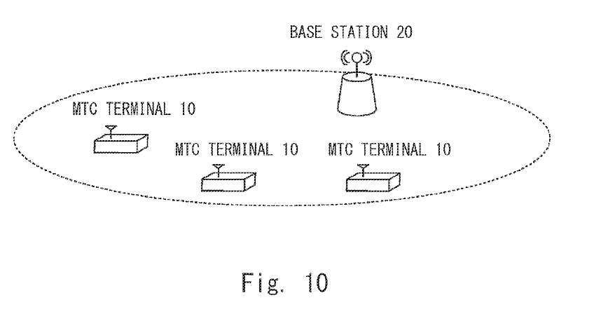

FIG. 10 is a schematic view of a wireless communication system according to the second exemplary embodiment.

The wireless communication system according to the second exemplary embodiment includes a plurality of MTC terminals 10 and a base station 20. Note that the base station 20 in the second exemplary embodiment is the same as the base station 20 in the first exemplary embodiment, and therefore the detailed description thereof is omitted.

FIG. 11 is a block diagram of the MTC terminal 10 according to the second exemplary embodiment.

In FIG. 11, the MTC terminal 10 includes an antenna 11, a transmission circuit 12, a reception circuit 13, a control circuit 14, a resistor 15, a switch 16, a battery 17, a timer 18, and a memory 19.

The transmission circuit 12 and the reception circuit 13 are parts that transmit and receive radio signals to and from the base station 20, respectively.

The memory 19 is a nonvolatile memory, and a measurement time of the timer 18 is stored therein.

The timer 18 measures an operating time from the start of operation of the MTC terminal 10, and stores the time into the memory 19. Even if the power of the MTC terminal 10 is turned off, because the memory 19 is a nonvolatile memory, the previous measurement time remains stored, and when the power is turned on again, the timer 18 performs the measurement by adding a time to the measurement time stored in the memory 19. Accordingly, the total operating time of the MTC terminal 10 from the initial power-on is stored in the memory 19.

The control circuit 14 monitors the measurement time stored in the memory 19, and when the measurement time exceeds a predetermined specified time, it controls the switch 16 (controls the switch 16 by generating the operation disabling instruction), and discharges electric power remaining in the battery 17 safely through the resistor 15 with an appropriate value, and thereby disables the operation of the transmission circuit 12 and the reception circuit 13.

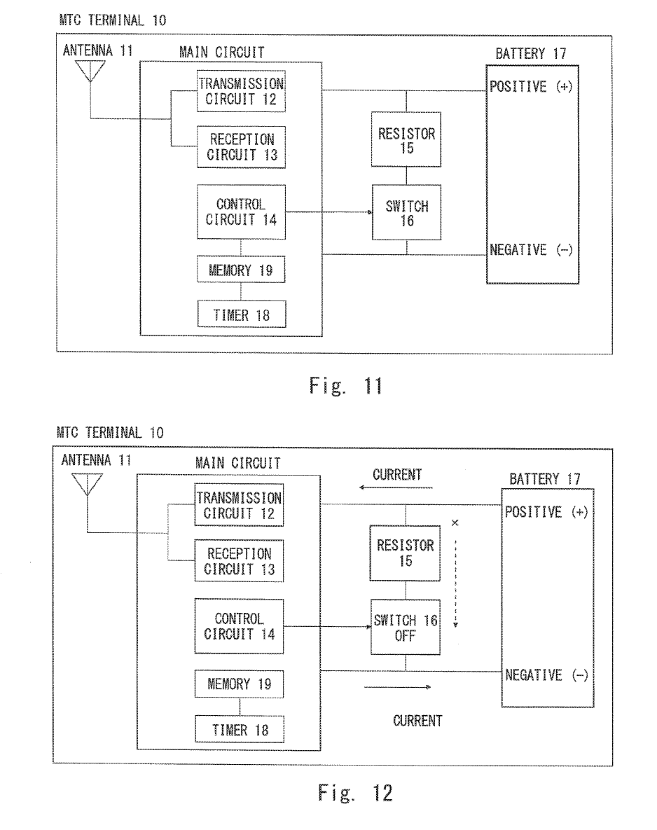

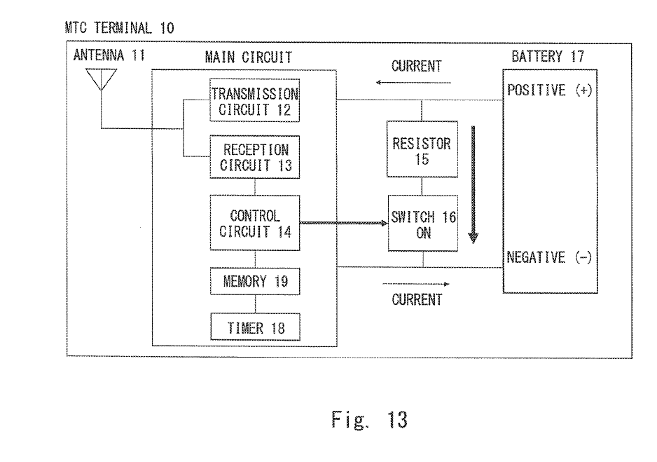

The processing for disabling the operation of the transmission circuit 12 and the reception circuit 13 by discharge of the battery 17 is described hereinafter. FIG. 12 is a view illustrating a current path at the time of normal operation, and FIG. 13 is a view illustrating a current path at the time of discharge of the battery 17.

First, as shown in FIG. 12, the control circuit 14 monitors the measurement time stored in the memory 19, and when the measurement time is within a predetermined specified time, it turns off the switch 16, and a current from the battery 17 is supplied to a main circuit that includes the transmission circuit 12, the reception circuit 13 and the control circuit 14. Thus, no current flows to the resistor 15 and the switch 16.

On the other hand, as shown in FIG. 13, the control circuit 14 monitors the measurement time stored in the memory 19, and when the measurement time exceeds a predetermined specified time, the control circuit 14 turns on the switch 16 (turns on the switch 16 by generating the operation disabling instruction). Then, a current from the battery 17 begins to flow also to the resistor 15 and the switch 16. As a result that a current from the battery 17 flows also to the resistor 15 and the switch 16, the remaining capacity of the battery 17 decreases rapidly. When the remaining capacity of the battery 17 falls below a normal capacity, the positive voltage of the battery 17 decreases, and at the point of time when it decreases to the minimum operating voltage at which the transmission circuit 12 and the reception circuit 13 can operate, the operation of the main circuit that includes the transmission circuit 12, the reception circuit 13 and the control circuit 14 stops, and thereby the transmission of radio waves from the antenna also stops.

By setting the current value flowing to the resistor 15 and the switch 16 to a value that does not exceed the maximum allowable discharge current (Imax) of the battery 17, it is possible to discharge the remaining capacity of the battery 17 safely. At this time, the rated power (Wr) of the resistor 15 (R) is calculated by the following equation from Ohm's Law based on the maximum discharge current (Imax) of the battery 17.

Wr(W)=Imax(A)²×R(Ω)

Then, the resistor 15 with a rated power that is twice or more the rated power (Wr) is selected in consideration of derating.

Further, the switch 16 may be a semiconductor device or a switch with a mechanical contact point. In the case of using the switch 16 which is a semiconductor device, a semiconductor device where the maximum allowable current of the semiconductor device is twice or more the maximum allowable discharge current of the battery 17 is selected in consideration of derating. Further, in the case of using the switch 16 with a mechanical contact point, the switch 16 where the maximum switching current is twice or more the maximum allowable discharge current of the battery 17 is selected.

The operation of the MTC terminal 10 in the wireless communication system according to the second exemplary embodiment is described hereinbelow.

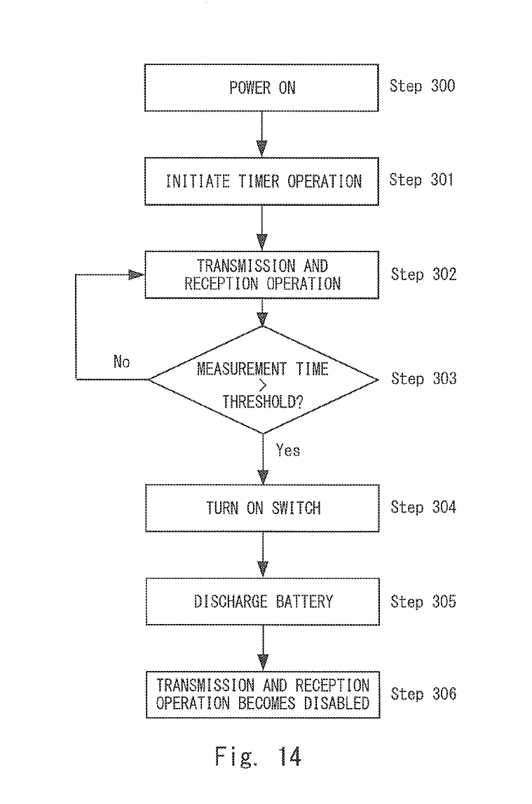

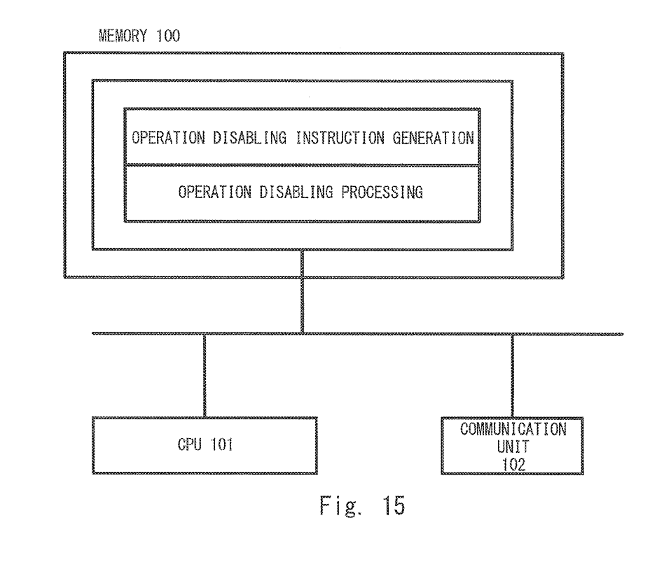

FIG. 14 is an operational flowchart of the MTC terminal 10 according to the second exemplary embodiment.

First, when the MTC terminal 10 is powered on (Step 300), the operation of the timer 18 is initiated and the measurement of the operating time is initiated (Step 301), and further the transmission operation of the MTC terminal 10 is initiated (Step 302).

The control circuit 14 monitors the measurement time stored in the memory 19 (Step 303), and when the measurement time stored in the memory 19 is within a predetermined threshold (operating time), it turns off the switch 16, and thereby a current from the battery 17 is supplied to a main circuit that includes the transmission circuit 12, the reception circuit 13 and the control circuit 14, and a normal transmission and reception operation is performed (Step 302).

On the other hand, the control circuit 14 monitors the measurement time stored in the memory 19 (Step 303), and when the measurement time stored in the memory 19 exceeds a predetermined threshold (operating time), it turns on the switch 16 (turns on the switch 16 by generating the operation disabling instruction) (Step 304). Then, a current from the battery 17 begins to flow also to the resistor 15 and the switch 16. As a result that a current from the battery 17 flows also to the resistor 15 and the switch 16, the remaining capacity of the battery 17 decreases rapidly (Step 305). When the remaining capacity of the battery 17 falls below a normal capacity, the positive voltage of the battery 17 decreases, and at the point of time when it decreases to the minimum operating voltage at which the transmission circuit 12 and the reception circuit 13 can operate, the operation of the main circuit that includes the transmission circuit 12, the reception circuit 13 and the control circuit 14 stops, and the transmission of radio waves from the antenna also stops, and thereby the transmission and reception operation of the MTC terminal 10 becomes disabled (Step 306).

As described above, this exemplary embodiment has an advantageous effect that the MTC terminal enters the transmission and reception stopped or disabled state autonomously when a specified operating time has passed, and maintains this state to thereby reduce interference with the outside. Particularly, it is effective in the case of a service where the operating time of the MTC terminal is determined.

Further, as another advantageous effect, because the MTC terminal enters the transmission and reception stopped or disabled state autonomously when a specified operating time has passed, there is no need to control a message from the outside or the like.

Further, because it is possible to allow many MTC terminals to enter the transmission and reception stopped or disabled state just like in the first exemplary embodiment, it is significantly effective compared with recovery by humans and achieves cost reduction.

Further, because electric power remaining in the battery of the MTC terminal is discharged through the resistor with an appropriate value just like in the first exemplary embodiment, it is possible to allow the MTC terminal to enter the transmission and reception stopped or disabled state safely.

Further, as is obvious from the above description, each of the units of the wireless terminal can be implemented by hardware, and they can be implemented also by a computer program. In this case, the same functions and operation as those described in the above exemplary embodiments are implemented by a processor that operates by a program stored in a program memory.

To be specific, as shown in FIG. 15, they may be implemented by a computer system composed of a memory 100, a CPU 101, and a communication unit 102. In this case, a program that performs processing corresponding to the operation disabling instruction generation unit 2 and the operation disabling unit 3 described above is stored in the memory 100. The CPU 101 executes the program stored in the memory 100, and thereby the functions of the operation disabling instruction generation unit 2 and the operation disabling unit 3 are implemented.

Further, the whole or part of the exemplary embodiments disclosed above can be described as, but not limited to, the following supplementary notes.

### [Supplementary Note 1]

A wireless terminal comprising:

an operation disabling instruction generation means for generating an operation disabling instruction that disables a transmission operation of a wireless terminal based on a specified trigger; and

an operation disabling means for disabling the transmission operation of the wireless terminal based on the operation disabling instruction.

### [Supplementary Note 2]

The wireless terminal according to Supplementary note 1, wherein

the specified trigger is a message related to disabling a transmission operation of a wireless terminal transmitted from a wireless network, and

the operation disabling instruction generation means generates the operation disabling instruction when the message is received.

### [Supplementary Note 3]

The wireless terminal according to Supplementary note 1, wherein

the operation disabling instruction generation means has a timer for measuring a time, and

the operation disabling instruction generation means generates the operation disabling instruction when the time measured by the timer exceeds a specified threshold.

### [Supplementary Note 4]

The wireless terminal according to any one of Supplementary notes 1 to 3, wherein the operation disabling means disables the transmission operation of the wireless terminal by discharging a battery of the wireless terminal.

### [Supplementary Note 5]

The wireless terminal according to any one of Supplementary notes 1 to 4, wherein the wireless terminal is a Machine Type Communication (MTC) terminal.

### [Supplementary Note 6]

A wireless communication system comprising:

a transmission means for transmitting a message related to disabling a transmission operation of a wireless terminal;

an operation disabling instruction generation means for generating an operation disabling instruction that disables a transmission operation of a wireless terminal based on the message; and

an operation disabling means for disabling the transmission operation of the wireless terminal based on the operation disabling instruction.

### [Supplementary Note 7]

The wireless communication system according to Supplementary note 6, wherein the operation disabling means disables the transmission operation of the wireless terminal by discharging a battery of the wireless terminal.

### [Supplementary Note 8]

The wireless communication system according to Supplementary note 6 or 7, wherein the wireless terminal is a Machine Type Communication (MTC) terminal.

### [Supplementary Note 9]

A wireless communication method comprising:

generating an operation disabling instruction that disables a transmission operation of a wireless terminal based on a specified trigger; and

disabling the transmission operation of the wireless terminal based on the operation disabling instruction.

### [Supplementary Note 10]

The wireless communication method according to Supplementary note 9, wherein

the specified trigger is a message related to disabling a transmission operation of a wireless terminal transmitted from a wireless network, and

the operation disabling instruction is generated when the message is received.

### [Supplementary Note 11]

The wireless communication method according to Supplementary note 9, wherein

an operating time of a wireless terminal is measured, and

the operation disabling instruction is generated when the operating time measured by the timer exceeds a specified threshold.

### [Supplementary Note 12]

The wireless communication method according to any one of Supplementary notes 9 to 11, wherein the transmission operation of the wireless terminal is disabled by discharging a battery of the wireless terminal.

### [Supplementary Note 13]

The wireless communication method according to any one of Supplementary notes 9 to 12, wherein the wireless terminal is a Machine Type Communication (MTC) terminal.

### [Supplementary Note 14]

A program causing a computer to execute:

processing for generating an operation disabling instruction that disables a transmission operation of a wireless terminal based on a specified trigger; and

processing for disabling the transmission operation of the wireless terminal based on the operation disabling instruction.

### [Supplementary Note 15]

A wireless network comprising:

a trigger transmission means for transmitting, to a wireless terminal including an operation disabling instruction generation means for generating an operation disabling instruction that disables a transmission operation of a wireless terminal and an operation disabling means for disabling the transmission operation of the wireless terminal based on the operation disabling instruction, a trigger that activates generation of the operation disabling instruction.

### [Supplementary Note 16]

A wireless terminal comprising a memory and a processor, wherein the processor performs

operation disabling instruction generation processing for generating an operation disabling instruction that disables a transmission operation of a wireless terminal based on a specified trigger; and

operation disabling processing for disabling the transmission operation of the wireless terminal based on the operation disabling instruction.

### [Supplementary Note 17]

The wireless terminal according to Supplementary note 16, wherein

the specified trigger is a message related to disabling a transmission operation of a wireless terminal transmitted from a wireless network, and

the operation disabling instruction generation processing generates the operation disabling instruction when the message is received.

### [Supplementary Note 18]

The wireless terminal according to Supplementary note 16, wherein

the operation disabling instruction generation processing measures a time by a timer, and generates the operation disabling instruction when the time measured by the timer exceeds a specified threshold.

### [Supplementary Note 19]

The wireless terminal according to any one of Supplementary notes 16 to 18, wherein the operation disabling processing disables the transmission operation of the wireless terminal by discharging a battery of the wireless terminal.

### [Supplementary Note 20]

The wireless terminal according to any one of Supplementary notes 16 to 19, wherein the wireless terminal is a Machine Type Communication (MTC) terminal.

Although the present invention is described using preferred exemplary embodiments, the present invention is not necessarily limited to the above-described exemplary embodiments and may be varied in many ways within the scope of the technical idea of the present invention.

This application is based upon and claims the benefit of priority from Japanese patent application No. 2015-071601 filed on Mar. 31, 2015, the disclosure of which is incorporated herein in its entirety by reference.

### INDUSTRIAL APPLICABILITY

1 WIRELESS TERMINAL
2 OPERATION DISABLING INSTRUCTION GENERATION UNIT
3 OPERATION DISABLING UNIT
10 MTC TERMINAL
11 ANTENNA
12 TRANSMISSION CIRCUIT
13 RECEPTION CIRCUIT
14 CONTROL CIRCUIT
15 RESISTOR
16 SWITCH
17 BATTERY
18 TIMER
19 MEMORY
20 BASE STATION
21 RECEIVER
22 TRANSMITTER
23 SIGNAL PROCESSING UNIT
24 COMMUNICATION CONTROL UNIT
25 TERMINAL MANAGEMENT UNIT
30 APPLICATION SERVER
31 RECEIVER
32 TRANSMITTER
33 TRANSMISSION DATA MANAGEMENT UNIT
100 MEMORY
101 CPU
102 COMMUNICATION UNIT

1. A wireless terminal comprising:
an operation disabling instruction generation unit configured to generate an operation disabling instruction that disables a transmission operation of a wireless terminal based on a specified trigger; and
an operation disabling unit configured to disable the transmission operation of the wireless terminal based on the operation disabling instruction.

2. The wireless terminal according to claim 1, wherein
the specified trigger is a message related to disabling a transmission operation of a wireless terminal transmitted from a wireless network, and
the operation disabling instruction generation unit generates the operation disabling instruction when the message is received.

3. The wireless terminal according to claim 1, wherein
the operation disabling instruction generation unit has a timer for measuring a time, and
the operation disabling instruction generation unit generates the operation disabling instruction when the time measured by the timer exceeds a specified threshold.

4. The wireless terminal according to claim 1, wherein the operation disabling unit disables the transmission operation of the wireless terminal by discharging a battery of the wireless terminal.

5. The wireless terminal according to claim 1, wherein the wireless terminal is a Machine Type Communication (MTC) terminal.

6. A wireless communication system comprising:
a transmission unit configured to transmit a message related to disabling a transmission operation of a wireless terminal;
an operation disabling instruction generation unit configured to generate an operation disabling instruction that disables a transmission operation of a wireless terminal based on the message; and
an operation disabling unit configured to disable the transmission operation of the wireless terminal based on the operation disabling instruction.

7. The wireless communication system according to claim 6, wherein the operation disabling unit disables the transmission operation of the wireless terminal by discharging a battery of the wireless terminal.

8. The wireless communication system according to claim 6, wherein the wireless terminal is a Machine Type Communication (MTC) terminal.

9. A wireless communication method comprising:
generating an operation disabling instruction that disables a transmission operation of a wireless terminal based on a specified trigger; and
disabling the transmission operation of the wireless terminal based on the operation disabling instruction.

10. The wireless communication method according to claim 9, wherein
the specified trigger is a message related to disabling a transmission operation of a wireless terminal transmitted from a wireless network, and
the operation disabling instruction is generated when the message is received.

11. The wireless communication method according to claim 9, wherein
an operating time of a wireless terminal is measured by a timer, and
the operation disabling instruction is generated when the measured operating time by the timer exceeds a specified threshold.

12. The wireless communication method according to claim 9, wherein the transmission operation of the wireless terminal is disabled by discharging a battery of the wireless terminal.

13. The wireless communication method according to claim 9, wherein the wireless terminal is a Machine Type Communication (MTC) terminal.

14. A non-transitory computer readable medium storing a program causing a computer to execute:
processing for generating an operation disabling instruction that disables a transmission operation of a wireless terminal based on a specified trigger; and
processing for disabling the transmission operation of the wireless terminal based on the operation disabling instruction.

15. A wireless network comprising:
a trigger transmission unit configured to transmit, to a wireless terminal including an operation disabling instruction generation unit configured to generate an operation disabling instruction that disables a transmission operation of a wireless terminal and an operation disabling unit configured to disable the transmission operation of the wireless terminal based on the operation disabling instruction, a trigger that activates generation of the operation disabling instruction.
